(19) United States
(12) Patent Application Publication
(10) Pub. No.: US 2009/0293036 A1
(43) Pub. Date: Nov. 26, 2009

(54) HARDWARE DESCRIPTION LANGUAGE AND A SYSTEM AND METHODS FOR ELECTRONIC DESIGN

(76) Inventor: Daniel Yau, Los Altos, CA (US)

Correspondence Address: Daniel Yau, 22161 Berkeley Court, Los Altos, CA, 94024, US

(21) Appl. No.: 12/125,188

(22) Filed: May 22, 2008

(51) Int. Cl. G06F 17/50

(52) U.S. Cl. 716/18

(57) ABSTRACT

A Hardware Description Language (HDL) comprising of a plurality of object commands, a plurality of compile commands and a plurality of comment styles is used in methods of electronic circuit design. An object command in the HDL defines a logic object, which can be as simple as a piece of wire or as complex as a priority-encoded arbitrator with a variable number of requesters. A Register Transfer Level (RTL) design in the HDL can be translated into a set of generic gates and instantiated library modules for design verification and synthesis. The design can also be translated to a target hardware description language such as Verilog-HDL or VHDL to feed into a conventional design flow.

### FIELD OF THE INVENTION

The presented invention relates to defining a hardware description language to specify the design of an electronic design, and to methods to translate the hardware description language to a standard hardware description language, such as Verilog-HDL or VHDL.

### BACKGROUND OF THE INVENTION

The standardized and well-accepted hardware description languages, Verilog-HDL and VHDL are defined primarily for verifying an electronic design. They emphasize the clarity of the behavior of the design coded in such languages. This emphasis requires the behavior details of a commonly used logic block being described every time such a logic block is written. It is time-consuming and error-prone to repeat such behavior description in the design process. A designer's primary interest to use a commonly used logic block is to connect them in the design, rather than to specify their behavior in the design. A designer wants to specify the behavior of a logic block only if the block is a customized block in the design.

The solution to this problem in the standard HDL is to use module instantiation. The behavior of an instantiated module need not be specified each time when it is instantiated. Only the connections of the instantiated module need to be specified. However, the module instantiation has the following drawbacks: (1) the instantiation of a logic block with a modest complexity requires as much code as specifying the behavior of the logic block; (2) the instantiation requires that the connection of every connected port being explicitly specified, while many of such connections are not of the primary interest of the designers; (3) the need to use a large number of variations of a commonly-used logic block pushes the proliferation of the modules in the design library to be instantiated.

One example of the drawback (1) above is a D-flip-flop. Writing an instantiation of a D-flip-flop is about as tedious as writing the behavior model of the D-flip-flop.

Examples of the drawback (2) above are the clock signal and the reset signal, which are very common in the port list of the sequential logic modules. Even though the connections of these signals are essential for the correct behavior of the modules, the repetitive typing of these port names and the signal names, to which they are connected, is counter-productive and is not the primary focus of the design work.

One example of the drawback (3) above is a family of decoders. If a designer may use binary decoders with input signals having a width from two bits to 8 bits, it is necessary to have seven decoder modules ready to be instantiated in the design library. The module proliferation can easily be too excessive if there is more than one variable of interest.

The current standard HDL does not have solutions for the drawbacks (1) and (2). The solution in the standard HDL for the drawback (3) is to use parameterized modules to create variations of a module to be instantiated. However, the parameterization has its limitations in such verification-centric standard HDL. For example, the module port name variations cannot be parameterized. The hardware description language of the present invention addresses the issues of all of these three drawbacks.

### BRIEF SUMMARY OF THE INVENTION

The present invention solves the problems in the drawbacks of the current standard HDL.

The invention defines a hardware description language to include a growable set of object commands. An object command can be used to describe a design object, simple or complex. The required information needed to write the object command is limited to such that are typically different from instance to instance. The information, which is typically identical among the instances in a design, is obtained from the predefined values of system variables, or from the values of user-defined variables, or from the information-generation mechanism defined by the command. Such information can also be specified in an object command instance when necessary.

The object command does not necessarily contain the information of the object behavior so that the repetitive coding of the behavior of a commonly used design object can be eliminated.

The object command does not necessarily require the information of the complete set of port connections between the object and the rest of the logic in the module, so that the coding of certain trivial port connections may be eliminated.

The object command may have a set of command options so that the instances of the object may vary from one to another, without the proliferation of the object commands.

The RTL design using the hardware description language is significantly simplified because much of the required information for the behavior of the objects in a conventional hardware description language is not needed for the RTL design using the hardware description language in this invention.

The behavior of an object is defined by the object command in the hardware description language. The definition of an object command and its command options is presented to users in a manual. A user writes an object command with confidence that the translation of the source code in the hardware description language will produce a code in a second hardware description language, with a behavior description as promised by the object command definition in the said manual.

For example, an object command Pedetect, is defined by the language as a logic block that detects the positive edge of a signal, with the input to the block being the signal to be detected and the output from the block being a signal carrying the result of the detection. The output signal uses a pulse, with a width of one clock cycle, to indicate the detection of a positive edge, on the cycle when the input signal making the low-to-high transition.

Given this definition, a positive-edge detector can be coded with only three pieces of information: (1) the object command name, i.e., Pedetect, (2) the input signal name, and (3) the output signal name. A method in this invention converts the given information to a full behavior description of the positive-edge detector in the targeted standard HDL language.

### BRIEF DESCRIPTION OF THE SEVERAL VIEWS OF THE DRAWINGS

The features of the invention are set forth in the claims. The invention in an illustrative embodiment may be best understood by reference to the following detailed description of the invention, taken in conjunction with the accompanying drawings, wherein:

FIG. 1 is a block diagram showing the process to translate a file containing codes of the hardware description language of this invention, or a file containing codes of the hardware description language of this invention, embedded in a second hardware description language.

FIG. 2 is an example of a piece of source code of the hardware description language and the translated Verilog-HDL code.

FIG. 3 is an example of some commands of the hardware description language embedded in a piece of Verilog-HDL codes and the translation of the same.

FIG. 4 is a block diagram showing the three parts of the language constructs in the hardware description language and the subsets of keywords therein.

FIG. 5 is an example of a set of alternative keywords and how the alternative keywords are recognized.

FIG. 6 is an example showing the use of system variables and user-defined variables.

FIG. 7 is an example showing five value types assigned to variables.

FIG. 8 is an example of a macro comment.

FIG. 9A is a flow chart showing the steps to translate source codes of the hardware description language.

FIG. 9B is a flow chart showing the steps to handle comments in the translation.

FIG. 9C is a flow chart showing the steps to handle an object command in the translation.

FIG. 9D is a flow chart showing the steps to handle a compile command in the translation.

FIG. 9E is a flow chart showing the steps to handle foreign texts.

FIG. 9F is a flow chart showing the steps to finalize the translation.

### DETAILED DESCRIPTION OF THE INVENTION

While this invention may be applied in the embodiments of various forms, it is shown in the drawings and will herein be described in specific embodiments. The detailed description in these specific embodiments is to be considered as examples of the invention and not to limit the invention in these embodiments as shown and described.

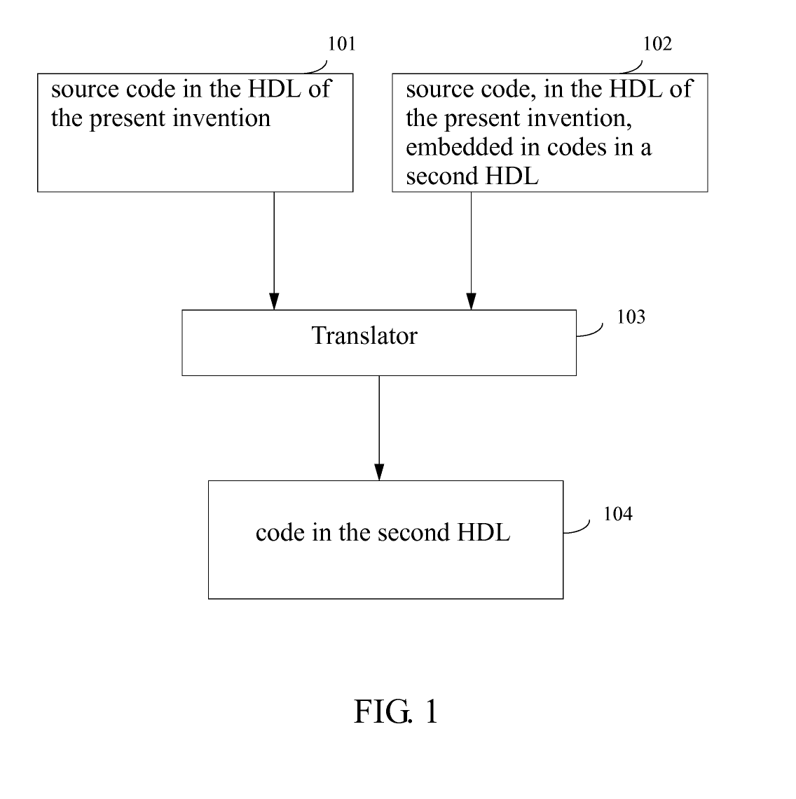

The present invention relates to a hardware description language that can be translated to a second hardware description language, such as Verilog-HDL or VHDL. The source codes may contain only the language constructs of the hardware description language, such as shown in 101 of FIG. 1, or it may contain the language constructs of the hardware description language embedded in the codes of a second hardware description language, as shown in 102 of FIG. 1. The source codes in 101, or the source codes in 102, can be read by a translator, shown in 103 of FIG. 1. The translator converts the source codes into codes in the second hardware description language, as shown in 104 of FIG. 1.

The codes in 104 can then be simulated and synthesized through the conventional design flow.

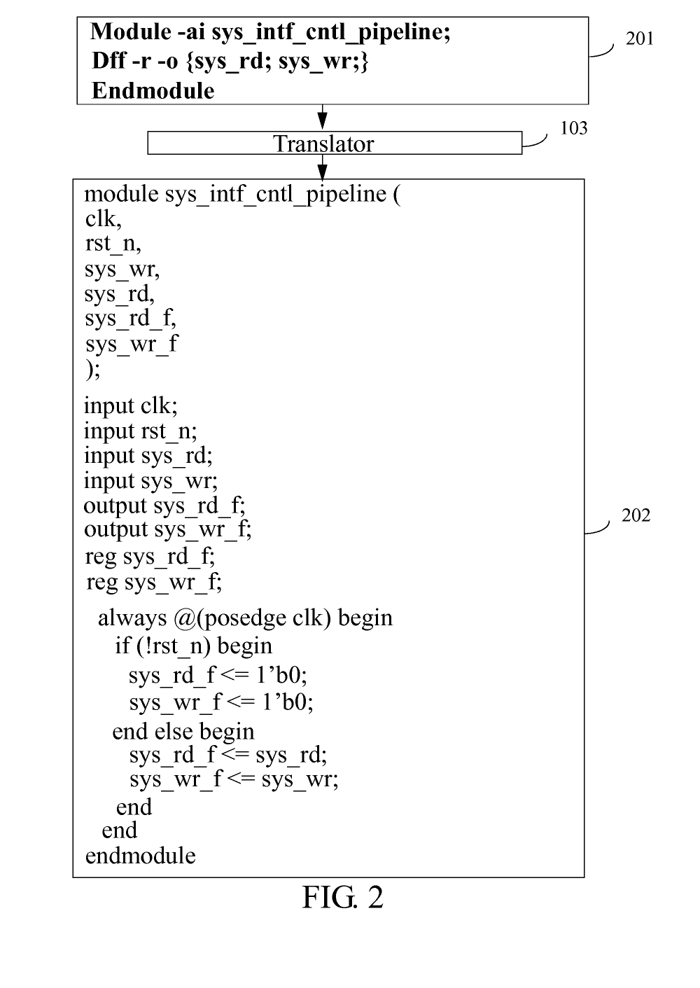

The source codes in 201 of FIG. 2 are an example of the source codes in the style in 101 of FIG. 1. The translator 103 of FIG. 2 is the same translator 103 of FIG. 1. The translator reads the source codes 201 and generates the codes in Verilog-HDL in 202 of FIG. 2.

The first line of the source codes in 201 is an object command Module. The Module command defines the characteristics of a module. The command option -ai indicates that the module should automatically generate input signals. The identifier sys_intf_cntl_pipeline is the name of the module.

The second line of the source codes in 201 is an object command Dff. The Dff command defines design objects D-flip-flops. There are two options in the command. The -r option indicates that the D-flip-flops defined by this command need to have synchronous reset. The -o option indicates that the generated q-port signal of each D-flip-flop is to be the output port of this module. Each of the two signal names, sys rd and sys wr, is a signal to be connected to the input d-port signal of a D-flip-flop.

The third line of the source codes in 201 is an object command Endmodule. The Endmodule command indicates the end of the source codes for the module.

With this information, the translator 103 generates Verilog-HDL codes that imply two D-flip-flops, as shown in 202. The clock signal name, clk, and the reset signal name, rst_n, are obtained from the default values of a system variable $_clk and a system variable $_r, respectively. The triggering edge is chosen to be “posedge” in the event expression of the always_construct in 202 based on the value of a system variable $_clkedge. The reset values of the D-flip-flops are based on the default value of a system variable $_rval.

The signal name of the q-port of a D-flip-flop is derived from the given signal name of the d-port, appended with a suffix _f which is obtained from the value of a system variable $_dff_sfx.

The input port names are derived by getting the names of all of the signals not generated in this module. The output port names are derived according to the -o option of the Dff command. The “reg” declarations are generated based on the information in the always_construct in the translated Verilog-HDL.

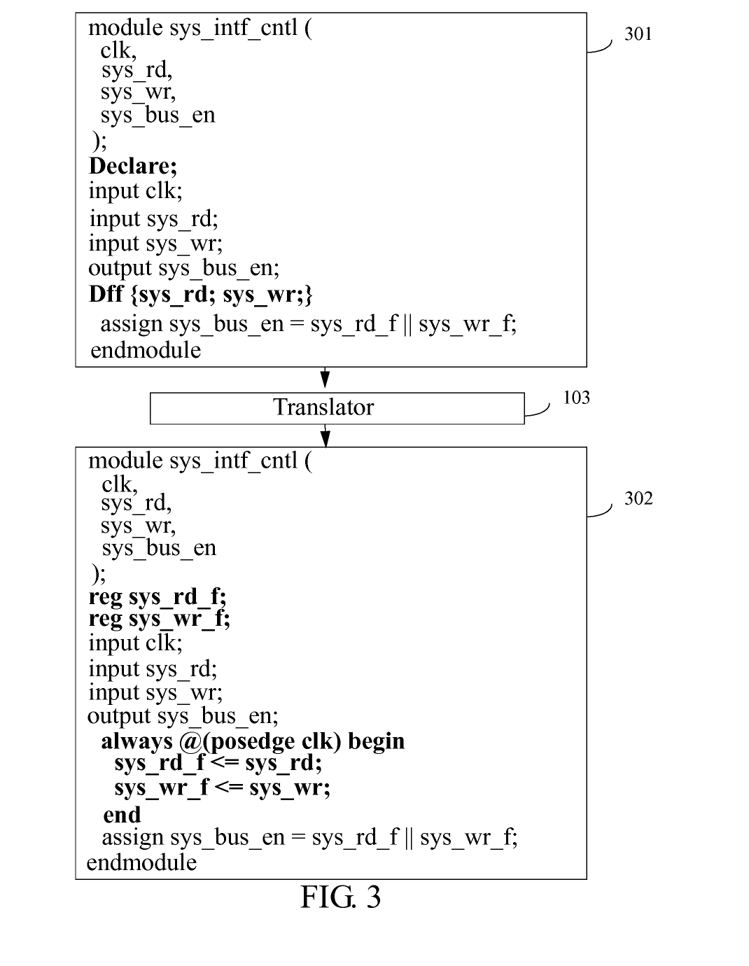

The source codes in 301 of FIG. 3 are an example of the source codes in the style in 102 of FIG. 1. The translator 103 of FIG. 3 is the same translator 103 of FIG. 1. The translator reads the source codes 301 and generates the codes in Verilog-HDL in 302 of FIG. 3.

There are only two lines of codes, which are in the hardware description language, in 301 of FIG. 3. These two lines are highlighted in the bold characters. The rest of the codes in 301 are Verilog-HDL codes.

The object command Declare in 301 indicates where the translated declaration codes should be placed. They are placed where the Declare command is, i.e., after the module declaration and before the input port declaration for the signal clk, in this example.

The object command Dff in 301 indicates a set of D-flip-flops is to be generated where the command is located.

After the source code 301 is translated, the Declare command is replaced by two reg declarations. The Dff command is replaced by an always_construct. The Verilog-HDL codes in the source codes are unchanged.

Note that there is no Module command in the source codes in this example. Hence, there is no automatic generation of the input port declarations. There is no -o option in the Dff command. Hence, there is no automatic generation of the output port declarations. There is no -r option in the Dff command. Hence, there is no reset code generated for the D-flip-flops.

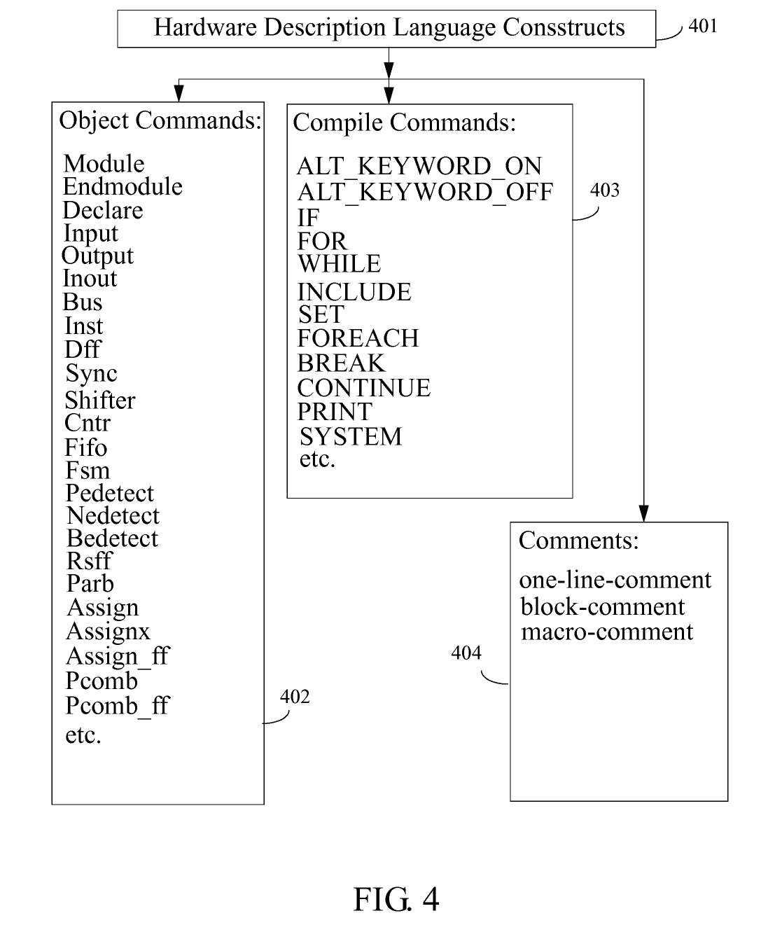

The hardware description language constructs 401 of FIG. 4 comprises of three parts: (1) the object commands 402, (2) the compile commands 403, and (3) comments 404.

A list of object command keywords is shown in 402. More object command keywords can be added to extend the language. Each object command defines a type of design object. The listed object command keywords are in the first keyword style of claim 4.

A list of compile command keywords is listed in 403. The compile commands do not define any specific design object. They assist to recognize, to include, to exclude, to set characteristics of, and to debug object commands. The listed compile command keywords are in the second keyword style of claim 5.

Three types of comments are listed in 404. The one-line-comment and the block comment are conventional comments. The macro-comment is in the present invention of claim 23.

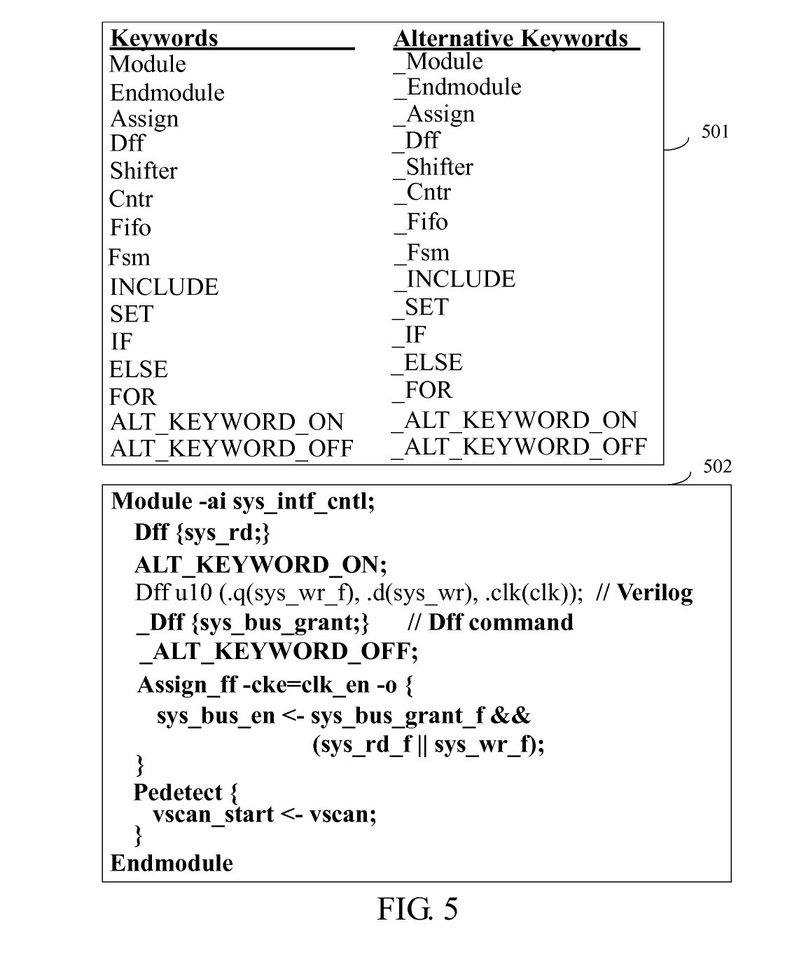

Each keyword in 501 of FIG. 5, in the left column, has a corresponding alternative keyword in 501 in the right column. To illustrate the use of the alternative keywords, an example is shown in 502 of FIG. 5. All of the constructs in the example in 502 are in the hardware description language of this invention except the Verilog-HDL instantiation of a module, with a module named Dff and an instance name u10. This instantiation is in regular character font to contrast to the bold character font, which is used for the non-Verilog-HDL codes.

The module name Dff is in conflict with an object command keyword Dff of this hardware description language. To avoid mistakenly interpreting the module name Dff as an object command keyword Dff, a compile command ALT_KEYWORD_ON is added before the Verilog-HDL instantiation. After the compile command, the translator recognizes only the alternative keywords. The module name Dff is not recognized as an object command keyword since it is not an alternative keyword. Hence, the word Dff is regarded as a foreign text and it is not translated. After the instantiation, an alternative keyword _Dff is recognized as the start of an object command. To return back to regular keyword mode, a compile command _ALT_KEYWORD_OFF is issued. The object command Assign_ff is then recognized since it has a regular keyword.

In the object command Assign_ff in 502, the -cke option illustrates that a command option may have an optional assigned value, as claimed in claim 10.

The object command Pedetect in 502 of FIG. 5 illustrates a derivative assignment of claim 11. The assignment indicates that the signal vscan_start on the left-hand-side of the derivative sign, <-, is derived by the signal vscan on the right-hand-side of the sign. However, it does not provide the details of how it is derived. The omission of the derivation details greatly simplifies the coding to generate the derived signal. The object command and the associated command options, if any, define the derivation details precisely. This mechanism provides a higher-level abstraction of the design objects. This mechanism is in claim 13.

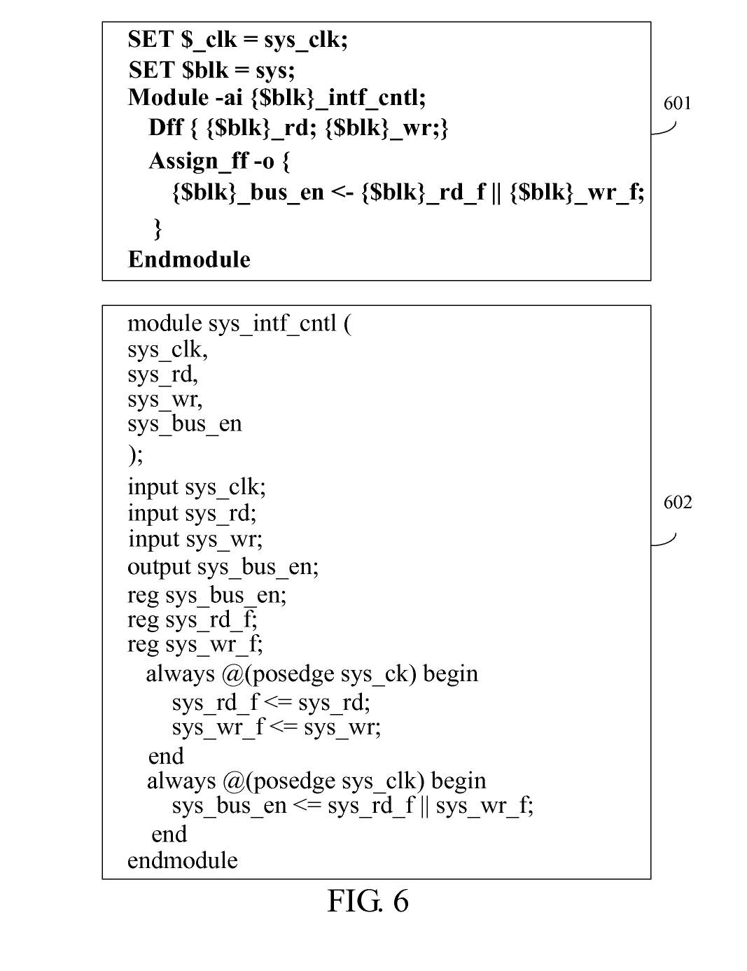

The source codes in 601 of FIG. 6 include two SET commands. The first SET command sets a system variable $_clk to a simple identifier sys_clk. After this command is executed, the reference to the variable $_clk gets sys_clk. The second SET command sets a user-defined variable $blk to a simple identifier sys. The following object command Module uses the variable $blk to be a part of the module name. The concatenated identifier {$blk}_intf_cntl is translated to sys_intf_cntl, as shown in the translated codes in 602 of FIG. 6.

The object commands Dff and Assign_ff use a default clock signal, which is obtained from the system variable $_clk. The value of the variable $_clk has been set to sys_clk. Hence, the event expressions in the always_constructs use sys_clk as the clock signal.

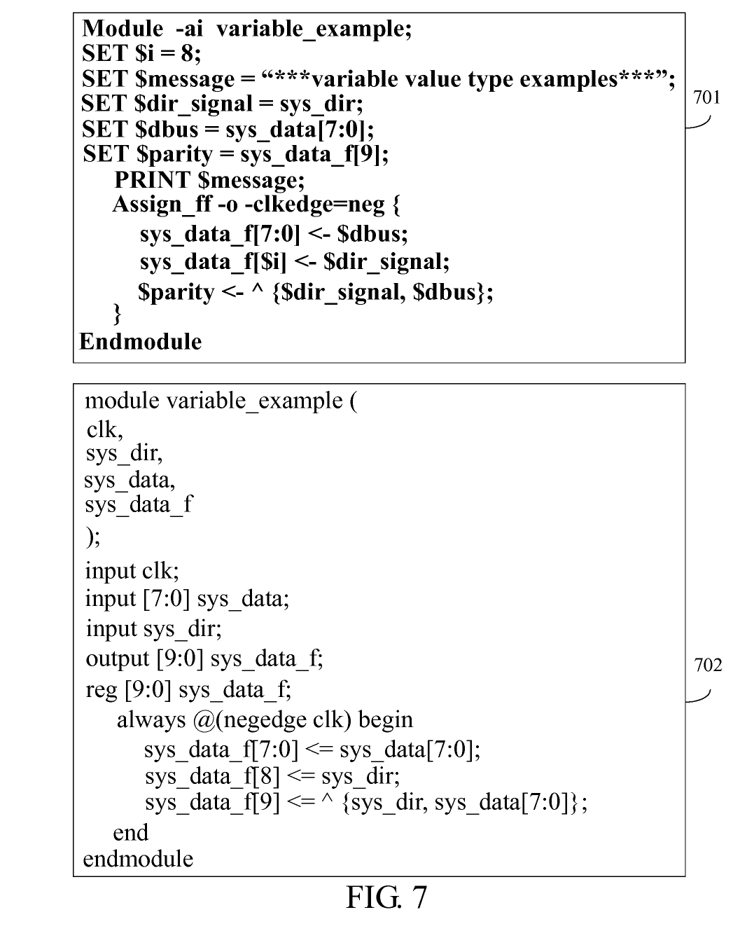

The example in 701 of FIG. 7 illustrates the five value types a variable can store. There are five SET commands in the example. Each command sets a variable to a distinct value type. The five types of variable values are number, string, simple identifier, bus and bus_bit_select.

A number is an integer number or a real number. The example shows an integer 8 assigned to a variable $i. The variable is used in the second derivative assignment in the Assign_ff command, as the index of the bus_bit_select sys_data f[$i]. The bus_bit_select is translated to sys_data f[8] as shown in the translated codes in 702 of FIG. 7. The variable $i is substituted by its value.

The example in 701 shows a string enclosed by a pair of double-quotes. It is assigned to a variable $message. The variable is used in the compile command PRINT. During the translation, the string is printed out to the standard output of the computer system, which is typically the monitor of the system.

The third variable value type in the example in 701 is a simple-identifier. The variable $dir_signal is set to a simple-identifier sys_dir. The variable is used in the right-hand-side of the second derivative assignment in the Assign_ff command. As shown in 702, the variable $dir_signal is substituted by its value during translation. It is also used in the right-hand-side of the last derivative assignment in the command, in a concatenation.

The fourth variable value type in the example in 701 is a bus sys_data[7:0]. This value indicates that the identifier of the bus is sys_data. The most-significant-bit of the bus is 7 and the least-significant-bit of the bus is 0. The bus is assigned to a variable $dbus. The bus is used on the right-hand-side of the first derivative assignment and the last derivative assignments in the Assign_ff command. As shown in 702, the variable $dbus is substituted by its value during translation.

The fifth variable value type in the example in 701 is a bus_bit_select sys_data_f[9]. This value indicates that the identifier of the bus_bit_select is sys_data_f. The bit index is 9. The bus_bit_select is assigned to a variable $parity. The variable is used in the last derivative assignment of the Assign_ff command. As shown in 702, the variable $parity is substituted by its value.

In the object command Assign_ff in 701, a -clkedge option specifies the triggering edge to be the negative edge of the clock signal by the option value neg. As shown in 702, the event expression in the always_construct uses negedge instead of the default value posedge, which is stored in the system variable $_clkedge. This illustrates the claim 20. The value of a system variable is used in an object command if the value is not locally specified. In this example, the value of the system variable $_clkedge is locally specified. The locally specified value overrides the system variable value.

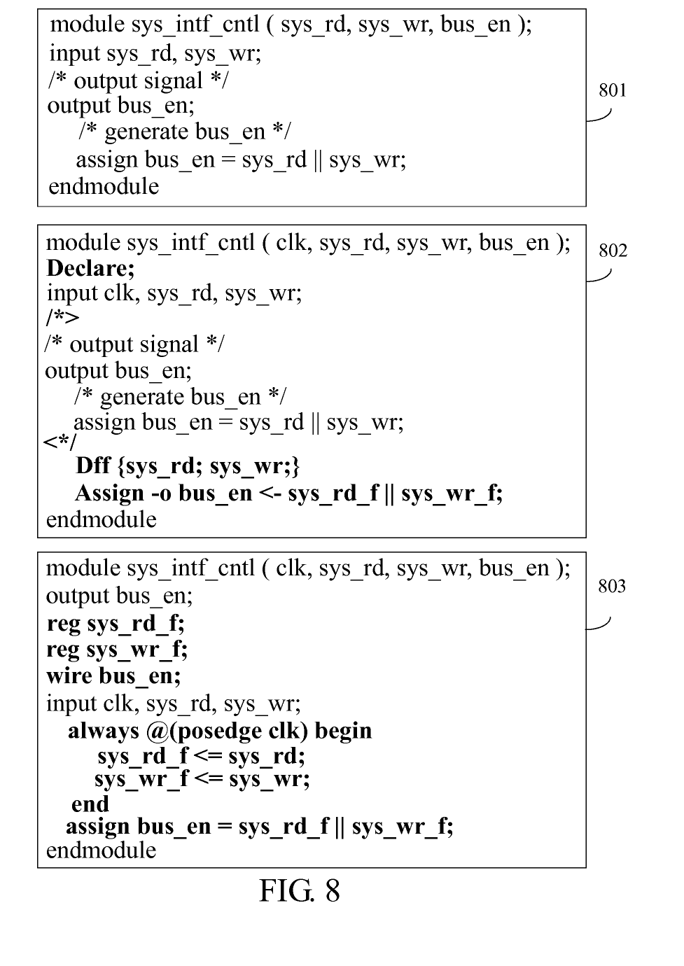

The FIG. 8 illustrates the use of a macro comment to modify a piece of Verilog-HDL code. The codes in 801 of FIG. 8 are a piece of Verilog-HDL codes. There is an assign-statement in the codes. There are two signals on the right-hand-side of the statement. They are sys rd and sys wr. If the designer wants to add one clock-cycle delay to these two signals before they are OR'ed together, as shown in the assign-statement, the constructs of the hardware description language of the present invention can be used to simplify the task.

The modified code is shown in 802 of FIG. 8. First, a Declare command is added after the module declaration. Secondly, the unwanted codes are commented out by using a macro comment. Note that the macro comment comments out two block comments in the region of the unwanted codes. This cannot be achieved easily by using only the conventional block comments and one-line comments. To accomplish this by the conventional comments, it needs to comment out each line in the region. It takes more time to do so than simply adding the characters for the macro-comment-start and for the macro-comment-end. It is also a lot easier to uncomment the codes in the macro comment if the designer has a second thought about the change.

The codes in 802 are translated to the codes shown in 803 of FIG. 8. The declarations are added where the Declare command is. The Dff command and the Assign command are translated accordingly. The codes, which are commented out by the macro comment, are removed during translation. As shown in 803, the macro comment is absent in the translated codes. This is different from the conventional comments used in other prior art preprocessors, where the commented-out codes are retained in the translated codes.

The macro comment provides an easy way to clean up old codes through the translation. It also makes the translated codes more readable.

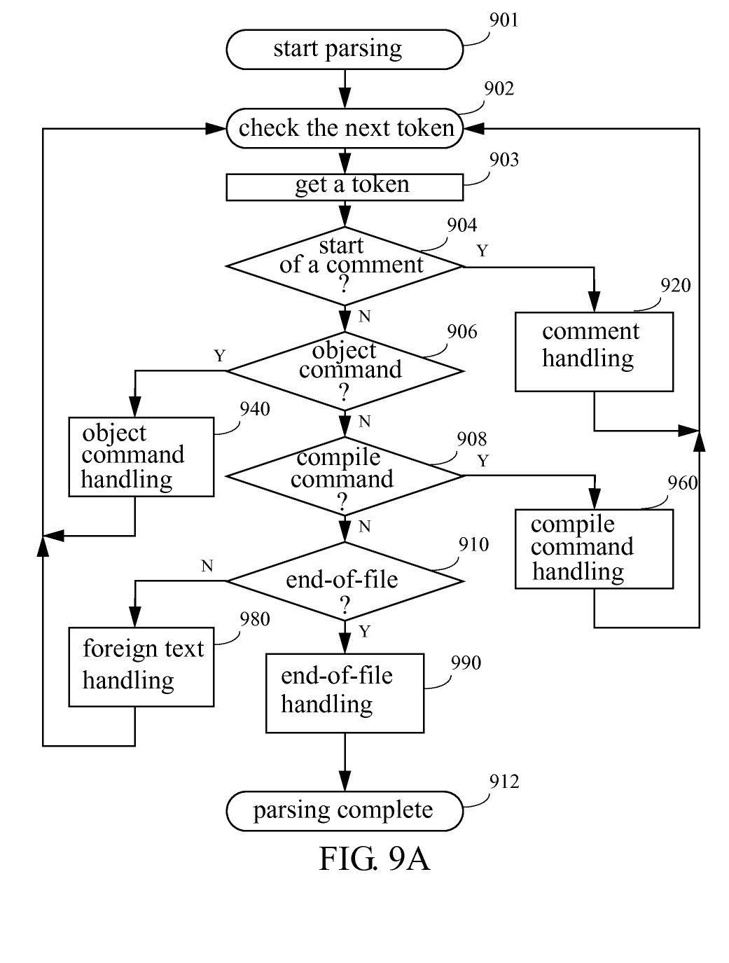

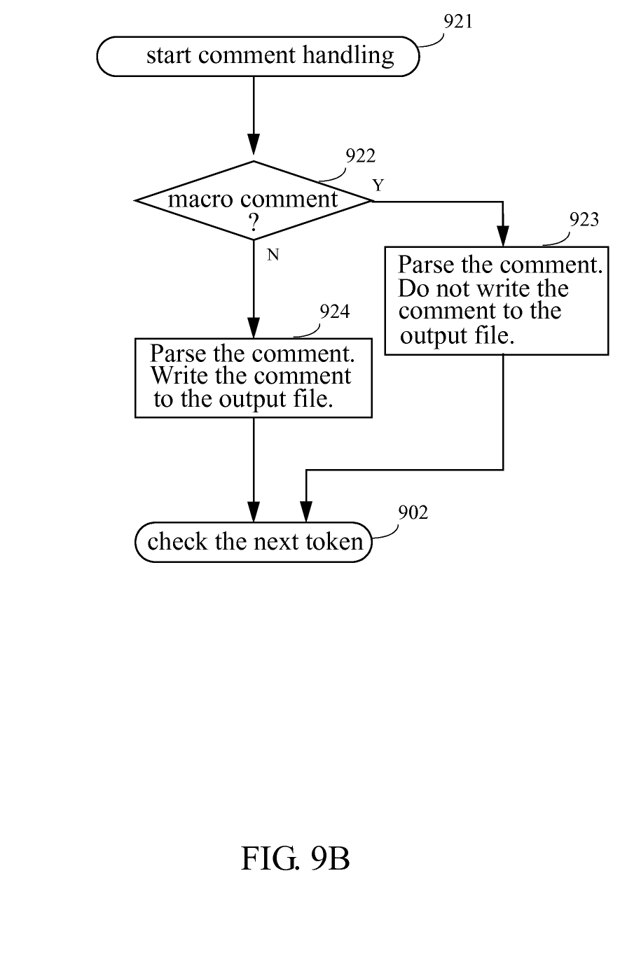

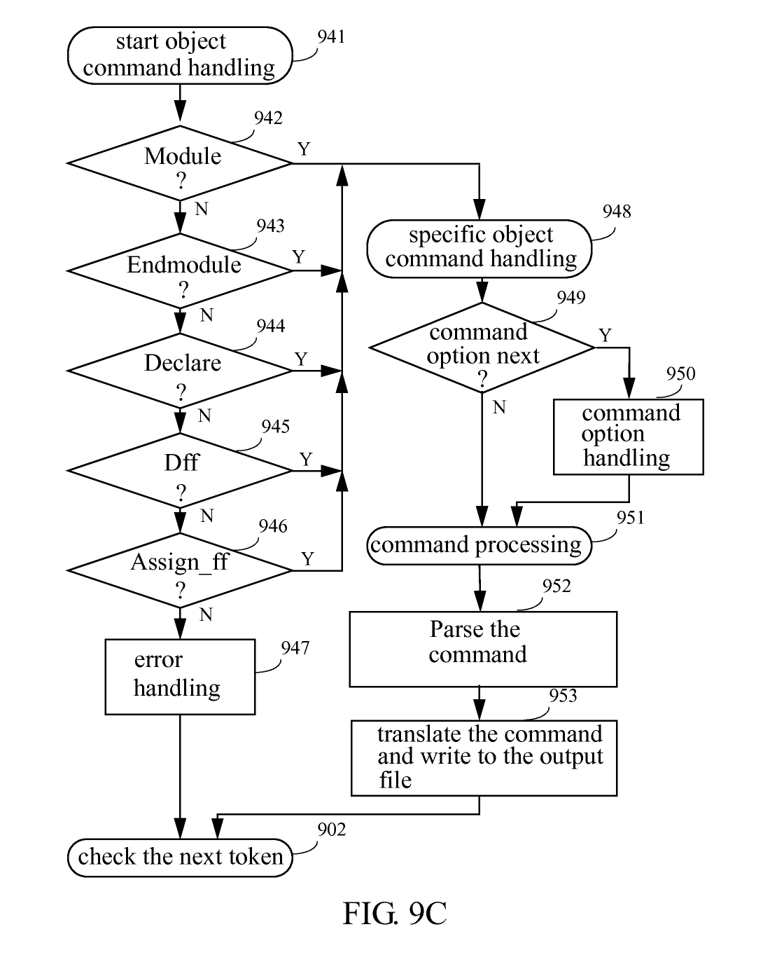

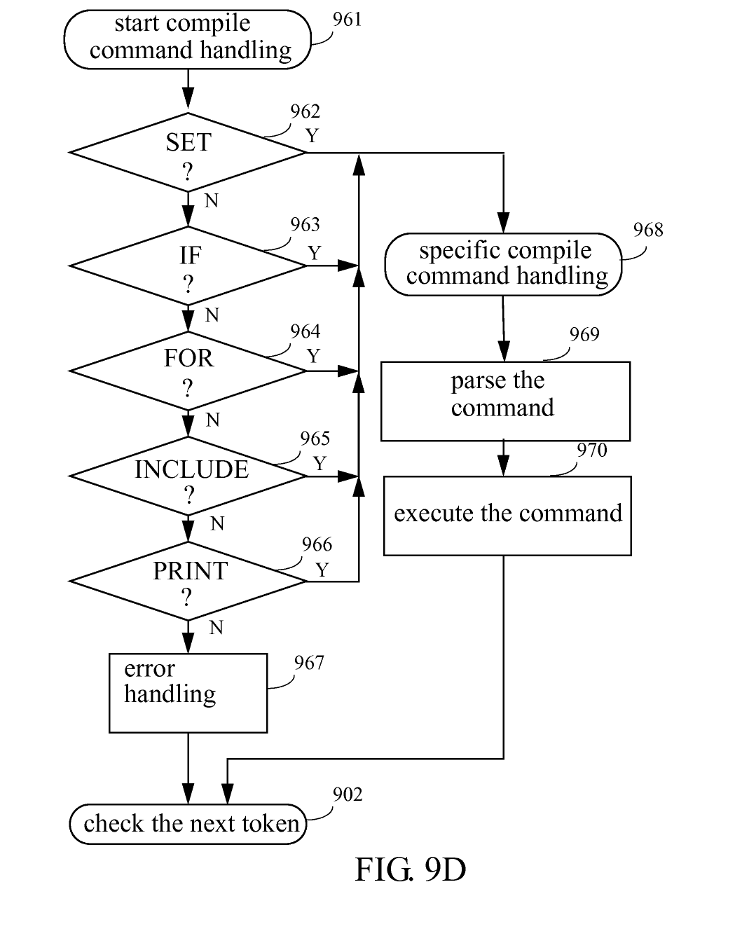

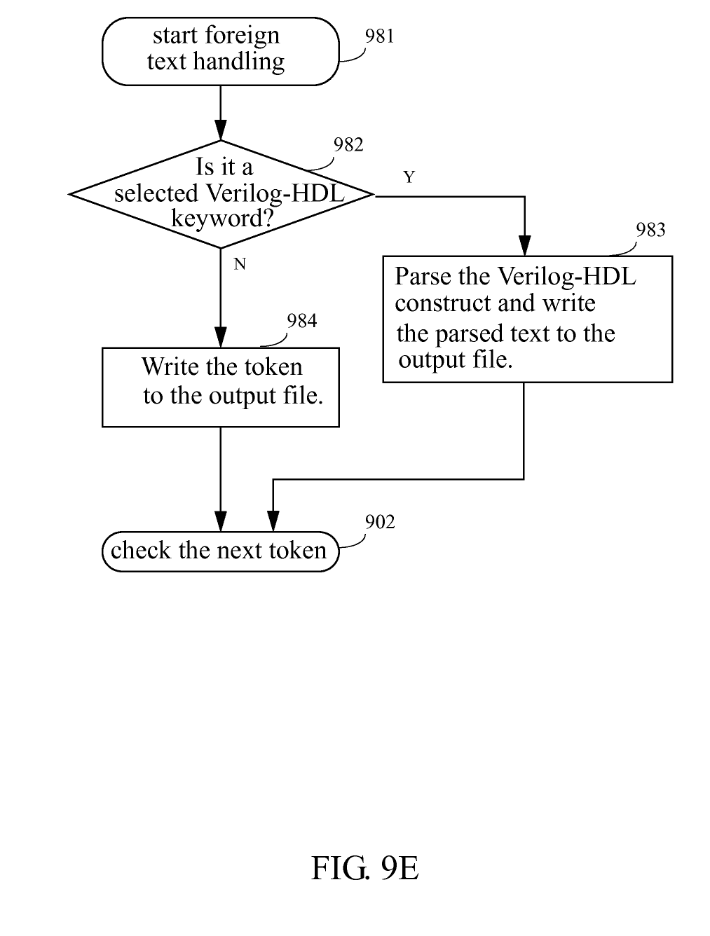

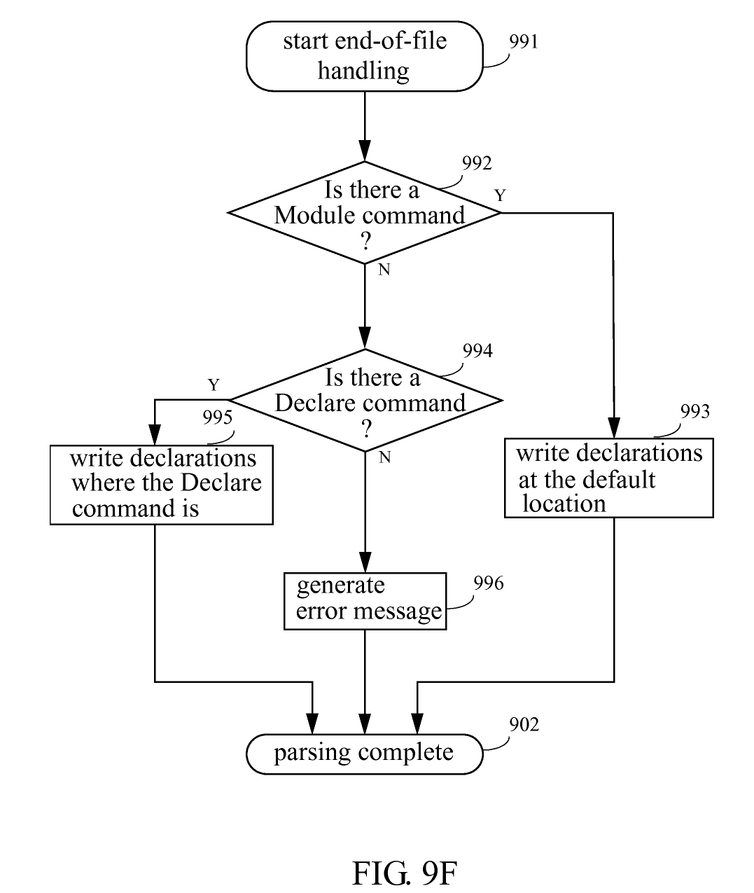

FIG. 9A shows the flow in the method of claim 24 and the method of claim 25. The two methods use the same flow in translation, as shown in FIG. 9A. The difference of the two methods is in the details of the object command handling in the step 940. The details of the step 940 are shown in FIG. 9C.

The step 901 of FIG. 9A is the start of the parsing process. At this step, a source file is read into the translator. The step 902 is the step to examine the source file, token by token, to look for the indication of the constructs in the hardware description language. The step 903 gets the next token. The step 904 checks if the token obtained in the step 903 is the start of a comment. If it is, the step 920 is executed to handle the comment. The details of the step 920 are in FIG. 9B. After the comment is processed, the process goes back to the step 902.

If the step 904 determines that the token is not the start of a comment, the process goes to the step 906 to determine if the token is a keyword to start an object command. If it is, the step 940 is executed to handle the object command. The details of the step 940 are in FIG. 9C. After the object command is processed, the process goes back to the step 902.

If the step 906 determines that the token is not the start of an object command, the process goes to the step 908 to determine if the token is a keyword to start a compile command. If it is, the step 960 is executed to handle the compile command. The details of the step 960 are in FIG. 9D. After the compile command is processed, the process goes back to the step 902.

If the step 908 determines that the token is not the start of a compile command, the process goes to the step 910 to determine if the token is the end-of-file. If it is not, the token is not recognized as the start of a construct in the hardware description language. The token is considered a foreign text. In this case, the step 980 is executed to handle the foreign text. The details of the step 980 are in FIG. 9E. After the foreign text is processed, the process goes back to the step 902.

If the step 910 determines that the token is the end-of-file, the process goes to the step 990 to handle the end of the file. The details of the step 990 are in FIG. 9F. After the end-of-file handling is complete, the process of parsing and translating the source file is complete.

The step 921 of FIG. 9B is the start of comment handling. The process proceeds to the step 922 to determine if the comment is a macro comment. If it is, the process proceeds to the step 923 to parse the macro comment. The macro comment is not written out to the translated output file. If the step 922 determines that the comment is not a macro comment, the process proceeds to the step 924 to parse the block comment or one-line comment. The block comment or the one-line comment is written out to the translated output file after it is parsed.

After the step 923 or the step 924, the comment handling is complete. The process goes back to the step 902.

The step 941 of FIG. 9C is the start of object-command handling. The process proceeds to determine which object command is encountered. It goes through a series of checking to identify the object command keyword. In the example in FIG. 9C, a subset of the object command keywords is checked. This set can be expanded to cover all of the current and future object command keywords.

The keywords shown in the example in FIG. 9C are Module which is checked in the step 942, Endmodule which is checked in the step 943, Declare which is checked in the step 944, Dff which is checked in the step 945, and Assign_ff which is checked in the step 946.

If the result of any of the checks in the steps of the previous paragraph is affirmative, the step 948 is taken to handle each of the specific object command. The first step in handling the specific object command is to check if there is any command option following the object command keyword. The check is done in the step 949. If the check in the step 949 determines there is command option, the step 950 is taken to handle the command option. In the step 950, each command option is parsed, and the values of the appropriate system variables are locally modified according to the parsed command option. The command option is parsed one-by-one until the command options are exhausted. The scope of the locally modified values is only the current command. The modification does not effect other commands.

After the step 950 is complete, or after the check in the step 949 determines that there is no command option for the object command, the process proceeds to the step 951, which starts to process the command syntax body.

In processing the command syntax body, the first step is to parse the command syntax body, as shown in the step 952. The syntax body is command dependent and is defined by the hardware description language in its documentation. After the syntax is parsed, the syntax is translated and written out to the translated output file, as shown in the step 953.

The translation in the step 953 has two methods. For the method of the claim 24, the object command is translated into Verilog-HDL primitive gates and instantiated library modules. For the method of the claim 25, the object command is translated into the constructs of a second hardware description language.

After the step 953, the process goes back to the step 902.

If the token does not match any object command keyword, the process goes to error handling in the step 947. In this step, the process reports the error. After the step 947, the process goes back to the step 902.

The step 961 of FIG. 9D is the start of compile-command handling. The process proceeds to determine which compile command is encountered. It goes through a series of checking to identify the compile command keyword. In the example in FIG. 9D, a subset of the compile command keywords is checked. This set can be expanded to cover all of the current and future compile command keywords.

The keywords shown in the example in FIG. 9D are SET which is checked in the step 962, IF which is checked in the step 963, FOR which is checked in the step 964, INCLUDE which is checked in the step 965, and PRINT which is checked in the step 966.

If the result of any of the checks in the steps of the previous paragraph is affirmative, the step 968 is taken to handle each of the specific compile command.

The first step in the compile-command processing is to parse the command, as shown in the step 969. The compile command is parsed based on the syntax defined for the specific compile command being processed.

After the compile command is successfully parsed, the compile command is executed, as shown in the step 970. The execution is done based on the definition of the specific compile command being executed.

In the step 970, the execution flow of some conditional compile commands, such as the IF command, depends on the evaluation result of the conditional expression. If the result is true, the block of commands in the IF-clause is active and is translated. If the result is false, the block of commands is inactive and is not translated. The inactive commands do not induce the generation of port declaration or signal type declaration.

After the step 970, the process goes back to the step 902.

If the token does not match any compile command keyword, the process goes to error handling in the step 967. In this step, the process reports the error. After the step 967, the process goes back to the step 902.

The step 981 of FIG. 9E is the start of the foreign-text handling. The first step in handling the foreign text is to check if the token is a selected keyword in a second hardware description language. In this example, a selected Verilog-HDL keyword is checked, as shown in the step 982. If the result of the check is negative, the process proceeds to the step 984. In the step 984, the token is written out to the output file and the process goes back to the step 902. If the result is affirmative, the process proceeds to the step 983. In the step 983, the construct led by the selected keyword of the second hardware description language is parsed. The parsed text is written to the output file. In this example, the step 983 shows that Verilog-HDL is the second hardware description language in this embodiment.

The step 991 of FIG. 9F is the start of end-of-file handling. The first step in the handling of end-of-file token is the step 992. In this step, the process checks if there is a Module command encountered in the source file. If there is a Module command, the step 993 is taken. In the step 993, the generated declarations are written out to the output file at a default location. The default location is determined based on the targeted second hardware description language. For example, if the hardware description language is translated to Verilog-HDL, the default location is the line after the Verilog-HDL module declaration.

In the step 993, a module port declaration file is generated. The file contains only module port declaration information. The file is read when the module is instantiated by an object command Inst. The information in this file supplements the information in the Inst command so that the Inst command can be simplified.

After the step 993, the process goes back to the step 902.

If the check in the step 992 is negative, a second check is done in the step 994. In this step, the process checks if there is a Declare command encountered in the source file. If there is a Declare command, the step 995 is taken. In the step 995, the generated declarations are written out to the output file at the location where the Declare command is found.

In the step 995, a module port declaration file is generated. The file contains only module port declaration information. The file is read when the module is instantiated by an object command Inst. The information in this file supplements the information in the Inst command so that the Inst command can be simplified.

After the step 995, the process goes back to the step 902.

If the check in the step 994 is negative, the step 996 is taken. In this step, an error message is generated to report that there is no information to determine where the generated declarations to be written.

After the step 996, the process goes back to the step 902.

The foregoing describes the present invention and its preferred embodiments. There are numerous modifications and variations are expected to occur to those skilled in the art, in the practice of this invention. Therefore, the embodiments described herein should be taken as illustrative and not restrictive.

What is claimed is:

1. A hardware description language (HDL) comprising a plurality of object commands and a plurality of compile commands and a plurality of comment styles, wherein an object command of the said hardware description language can define a logic object of a variety of complexity.

2. The hardware description language of claim 1, wherein the syntax of an object command starts with an object-command keyword, followed by optional command options, followed by the rest of the object command syntax, and the syntax of a compile command starts with a compile-command keyword, followed by the rest of the compile command syntax.

3. The object-command keyword and the compile-command keyword of claim 2, wherein the object-command keyword is in a first keyword style and the compile-command keyword is in a second keyword style, which is a different style from the first keyword style.

4. The first keyword style of claim 3, wherein in one embodiment of the invention, the first character of the first keyword style is a capitalized letter and the remaining letter or letters in the keyword are lower-case letter or letters.

5. The second keyword style of claim 3, wherein in one embodiment of the invention, the first character of the compile-command keyword is a capitalized letter and the remaining letter or letters in the keyword are capitalized letter or letters.

6. The first keyword style of claim 3, wherein the object-command keyword can be replaced by an alternative object-command keyword, which starts by an underscore, followed by the replaced keyword.

7. The second keyword style of claim 5, wherein the compile-command keyword can be replaced by an alternative compile-command keyword, which starts by an underscore, followed by the replaced keyword.

8. The hardware description language of claim 1, wherein the set of object commands includes D-flip-flop (Dff), synchronizer (Sync), shifter (Shifter), counter (Cntr), fifo (Fifo), finite-state-machine (Fsm), positive-edge-detector (Pedetect), negative-edge-detector (Nedetect), both-edge-detector (Bedetect), RS-flip-flop (Rsff), priority arbitrator (Parb) and instantiation (Inst).

9. The set of object commands of claim 8, wherein additional commands can be added to the set to extend the hardware description language.

10. The command options of claim 2, wherein the syntax of an option starts with a dash (−), followed by the option name, followed by an optional equal sign (=) and an option value.

11. The rest of the object command syntax of claim 2, wherein the syntax includes a derivative assignment in a form of a logic assignment left-hand-side (lhs), followed by a derivative sign, followed by a logic assignment right-hand-side (rhs).

12. The derivative sign of claim 11, wherein the sign is a two-character sequence (<-), which is a less-than-symbol (<), followed by a dash (−).

13. The lhs and the rhs of claim 11, wherein the right-hand-side does not necessarily contain all of the dependent signals to generate the signals on the left-hand-side, and the right-hand-side does not necessarily contain all of the information to determine the behavior of the signals on the left-hand-side.

14. The hardware description language of claim 1, wherein the object commands and the compile commands can be embedded in the source code of a second hardware description language.

15. The second hardware description language of claim 14, wherein the second hardware description language includes one of Verilog-HDL and VHDL.

16. The hardware description language of claim 1, wherein a compile command SET can set the value of a system variable or the value of a user-defined variable.

17. The value of claim 16, wherein the value can be a number, a string, a simple identifier, a bus, or a bus bit-select, wherein a number is an integer or a real number; a string is a series of zero or more characters enclosed by a pair of double-quotes; a simple identifier is a series of one or more characters which are letters, or digits, or underscores; a bus is a simple identifier, followed by a bus range which indicates the most-significant-bit index and the least-significant-bit index; and the bus_bit_select is a simple identifier, followed by a bit index.

18. The system variable and the user-defined variable of claim 16, wherein the name of a system variable is in a first name domain, and the name of a user-defined variable is in a second name domain, which is different from the first name domain, by restricting of the use of the character set in the name of the variable.

19. The system variable and the user-defined variable of claim 16, wherein in one embodiment of the invention, the second character of a system variable is an underscore and the second character of a user-defined variable is not an underscore.

20. The system variable of claim 16, wherein an object command uses the value of the variable if the value is not locally specified in the object command.

21. The system variable and the user-defined variable of claim 16, wherein the variables are used in identifiers, in indexes, and in concatenations in expressions.

22. The comment styles of claim 1, wherein the comment styles comprising a macro comment, a block comment and a one-line comment.

23. The macro comment of claim 22, wherein a macro comment starts with a first three-character sequence (/*>), which is a slash (/), followed by an asterisk (*), followed by a greater-than-symbol (>), and ends with a second three-character sequence (<*/), which is a less-than-symbol (<), followed by a asterisk (*), followed by a slash (/).

24. A method to translate the source codes containing only the object commands, the compile commands and comments of the hardware description language of claim 1, wherein the source codes are translated into Verilog-HDL primitive gates and instantiated library modules.

25. A method to translate the source codes containing the object commands, the compile commands and comments of the hardware description language of claim 1, and the constructs of a second hardware description language, wherein the source codes are translated into the constructs of the second hardware description language.

26. The method of claim 25, wherein the keyword conflict, against the words in the codes of the second hardware description language, is resolved by using alternative keywords.

27. The method of claim 25, wherein the source codes can be removed in the translation by using macro comments.

28. The method of claim 25, wherein the constructs of the second hardware description language in the source codes are left intact without any change in translation.

29. The method of claim 25, wherein only the declaration of the ports, such as input, output and inout in Verilog-HDL, and the declaration of the signal types, such as reg and wire in Verilog-HDL, of the second hardware description language, in one embodiment of the invention, are recognized in translation.

30. The method of claim 25, wherein a file containing port declarations is generated to facilitate module instantiation compilation.

31. The method of claim 25, wherein the module port declarations are automatically generated in translation from the information generated by each active object commands in the source code.

32. A computer readable medium containing executable instructions which, when executed in a processing system, causes the system to parse and to translate the source file containing only the object commands, compile commands and comments of the hardware description language of claim 1.

33. A computer readable medium containing executable instructions which, when executed in a processing system, causes the system to parse and to translate the source file containing the object commands, compile commands and comments of the hardware description language of claim 1, and the language constructs of a second hardware description language.
